(19) United States
(12) Patent Application Publication
(10) Pub. No.: US 2016/0053345 A1
(43) Pub. Date: Feb. 25, 2016

(54) PROCESS FOR ISOLATION AND PURIFICATION OF ASTATINE-211

(71) Applicant: University of Washington, Seattle, WA (US)

(72) Inventors: D. Scott Wilbur, Edmonds, WA (US); Ming-Kuan Chyan, Seattle, WA (US); Donald K. Hamlin, Edgewood, WA (US); Katherine Gagnon, Edmonton (CA); Shigeki Watanabe, Tokai (JP)

(21) Appl. No.: 14/832,554

(22) Filed: Aug. 21, 2015

Related U.S. Application Data
(60) Provisional application No. 62/040,340, filed on Aug. 21, 2014.

(51) Int. Cl. C22B 61/00; G21G 4/04

(52) U.S. Cl. CPC C22B 61/00; G21G 4/04

(57) ABSTRACT

This disclosure relates to methods for purifying and isolating astatine-211 from bismuth metal. Also disclosed are automated methods for purifying and isolating astatine-211 from bismuth metal.

### CROSS-REFERENCE TO RELATED APPLICATIONS

The present application claims priority to U.S. Provisional Patent Application No. 62/040,340, filed Aug. 21, 2014, which is entirely incorporated by reference herein for all purposes.

### STATEMENT OF GOVERNMENTS RIGHTS

This invention was made with government support under DE-SC0010502 awarded by US Department of Energy. The government has certain rights in the invention.

### BACKGROUND OF THE INVENTION

1. Field of the Invention

The present disclosure is generally directed to methods for purifying and isolating astatine-211 from bismuth metal.

2. Description of Related Art

Unless otherwise indicated herein, the materials described in this section are not prior art to the claims in this application and are not admitted to be prior art by inclusion in this section.

Astatine-211 is a promising α-emitting radionuclide for targeted radionuclide therapies. With a half-life (t_{1/2}) of 7.21 h, astatine-211 is stable enough to be prepared, undergo quality control, and be administered before an appreciable amount of decay occurs. Astatine-211 also does not have high energy γ-rays or long-lived α-emitting daughter radionuclides.

Astatine-211 is not naturally abundant in bismuth, and is therefore typically produced from the activation of bismuth-209 in a cyclotron via the ²⁰⁹Bi(α,2n)²¹¹At reaction. Dry distillation is widely used to isolate astatine-211 from the remaining bismuth, but this method can suffer from poor reproducibility and poor isolated yield, particularly when performed on large scale. A method that does not use dry distillation to isolate astatine-211 would be of significant value in the art.

### SUMMARY

In one aspect, the invention provides a method for purifying astatine-211 from bismuth metal. The method may include:
dissolving an amount of bismuth metal containing unpurified astatine-211 in nitric acid to provide a purification mixture;
adding the purification mixture onto a polyethylene glycol (PEG)-coated resin column;
eluting the column with an eluting acid;
eluting the column with an eluting base and collecting the eluted material;
concentrating the eluted material; and
isolating the purified astatine-211.

In some embodiments, the method further includes:
removing the nitric acid to provide an unpurified bismuth/astatine-211 residue; and
dissolving the residue in hydrochloric acid to provide the purification mixture.

In another aspect, the disclosure provides an automated method for purifying astatine-211 from bismuth metal. The method may include a non-transitory physical computer readable medium comprising a set of instructions to cause one or more devices to carry out the method of
dissolving an amount of bismuth metal containing unpurified astatine-211 in nitric acid to provide a purification mixture;
adding the purification mixture onto a polyethylene glycol (PEG)-coated resin column;
eluting the column with an eluting acid;
eluting the column with an eluting base and collecting the eluted material;
concentrating the eluted material; and
isolating the purified astatine-211.

In some embodiments, the automated method further includes:

removing the nitric acid to provide an unpurified bismuth/astatine-211 residue; and dissolving the residue in hydrochloric acid to provide the purification mixture.

### BRIEF DESCRIPTION OF THE DRAWINGS

FIG. 1 is a diagram depicting an automated method for the purification of astatine-211 from bismuth metal, in accordance with an example embodiment.

### DETAILED DESCRIPTION

This disclosure relates to techniques for purifying astatine-211 from bismuth metal. In one aspect, the disclosure provides a method for isolating astatine-211 by chromatographic purification. The method may include:
dissolving an amount of bismuth metal containing unpurified astatine-211 in nitric acid to provide a purification mixture;
adding the purification mixture onto a polyethylene glycol (PEG)-coated resin column;
eluting the column with an eluting acid;
eluting the column with an eluting base and collecting the eluted material;
concentrating the eluted material; and
isolating the purified astatine-211.

In a second aspect, the disclosure provides an automated method for purifying astatine-211 from bismuth metal. The method may include a non-transitory physical computer readable medium comprising a set of instructions to cause one or more devices to carry out the method as described herein.

In some embodiments, the method includes dissolving an amount of bismuth metal containing unpurified astatine-211 in nitric acid to provide a purification mixture. In some embodiments, the amount of bismuth metal is an amount of irradiated bismuth metal. The irradiation of bismuth metal may be conducted from any known process. For example, the bismuth metal may be obtained from the activation of bismuth-209 in a cyclotron using an alpha beam at about 28 to about 29 MeV.

The nitric acid used to dissolve the bismuth metal to provide the purification mixture can be about 8 to about 15 M. In some embodiments the nitric acid has a molarity of about 8 M. In other embodiments the nitric acid has a molarity of about 9 M, or about 10 M, or about 11 M or about 12 M. In some embodiments the nitric acid has a molarity of about 8 M to about 9 M, or about 8 M to about 10 M, or about 9 M to about 11 M, or about 10 M to about 12 M. In other embodiments where an automated system is used, the nitric acid has a molarity of about 10 M. In some embodiments, where greater than 12 M nitric acid is used to dissolve the bismuth metal, the resulting purification mixture is diluted before being added to the polyethylene glycol (PEG)-coated resin column. In some embodiments, the purification mixture is diluted so that is contains less than or equal to about 12 M nitric acid.

Unlike other known methods for purifying and isolating astatine-211, the method can include large amounts of bismuth metal containing unpurified astatine-211. For example, the purification mixture can include an amount of unpurified astatine-211 that is greater than about 10 milliCuries.

In some embodiments, the method further includes:

removing the nitric acid to provide an unpurified bismuth/astatine-211 residue; and

dissolving the residue in hydrochloric acid to provide the purification mixture. The removing of the nitric acid may be accomplished by any number of ways known in the art. For example, the nitric acid can be removed by subjecting the bismuth metal/nitric acid mixture to distillation. The distillation may include elevated temperature and optionally reduced pressure. In some embodiments, the unpurified bismuth/astatine-211 residue is provided by reducing the volume of the bismuth metal/nitric acid mixture, while in other embodiments, the nitric acid is substantially removed.

The unpurified bismuth/astatine-211 residue is then dissolved in hydrochloric acid. In some embodiments the hydrochloric acid has a molarity of about 8 M. In other embodiments the hydrochloric acid has a molarity of about 8 M to about 12 M, about 7 M to about 9 M, about 9 M to about 11 M, or about 8 M to 12 M. In some embodiments the hydrochloric acid has a molarity of about 6 M to about 10 M, or about 7 M to about 8 M, or about 9 M to about 11 M, or about 10 M to about 12 M. In embodiments where an automated system is used, the hydrochloric acid has a molarity of about 8M to about 10 M.

In some embodiments, the purification mixture is purified by column chromatography. The column can include an ion-exchange resin, cation-exchange resin or a polyethylene glycol (PEG)-coated resin. In embodiments where the column includes an ion-exchange resin, the resin can be at a pH of about 5 to about 10, and the purification mixture may be eluted with a solution of sodium hydroxide. In some embodiments, the solution of sodium hydroxide has a molarity of about 0.1 to 1 M. In other embodiments, the solution of sodium hydroxide has a molarity of about 0.2 M.

In some embodiments, the method includes adding the purification mixture onto a polyethylene glycol (PEG)-coated resin column. The PEG-coated resin column may be a Merrifield resin column coated with mPEG-OH. In some embodiments, the coated resin can have the structure of formula (I):

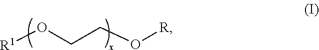

where R is the resin, R¹ is hydrogen, —C₁-C₁₂alkyl, —SiR′₃, —NHR₂, —NR′₃, —C(O)—C₁-C₁₂alkyl, —C₁-C₁₂alkyl—C(O)OR′ where R′ is hydrogen or —C₁-C₁₂alkyl, and x is such that the poly(ethylene glycol) portion of formula (I) has a number average molecular weight (Mₙ) of about 300 Dalton to about 6000 Dalton.

In certain embodiments, x is selected so that the Mₙ of the poly(ethylene glycol) falls within a range listed in each row of Table 1.

TABLE 1
Mₙ range of the poly(ethylene glycol) portion of the
coated resin (values are approximate).

| Low | High |
|---|---|
| 300 | 400 |
| 400 | 500 |
| 500 | 600 |
| 600 | 700 |
| 700 | 800 |
| 800 | 900 |
| 900 | 1,000 |
| 1,000 | 2,000 |
| 2,000 | 3,000 |
| 3,000 | 4,000 |
| 4,000 | 5,000 |
| 5,000 | 6,000 |

In certain embodiments, R¹ is methyl and x is such that the poly(ethylene glycol) portion has a number average molecular weight (Mₙ) of about 350 Dalton to about 5000 Dalton. For example, the resin may be coated with mPEG-OH having an average molecular weight of about 350 Dalton, about 750 Dalton, about 2,000 Dalton or about 5,000 Dalton.

Following the addition of the purification mixture to the coated resin column, the column is eluted with an acid. The eluting acid can be any acid that effectively separates the bismuth in the purification mixture from the desired astatine-211 on the resin. When the column is eluted with acid, the bismuth isotopes and compounds travel through the column while the astatine-211 remains. In some embodiments, the eluting acid is hydrochloric acid having a concentration of about 1M to about 3M. In some embodiments, the column is eluted with water after the eluting with acid and before the eluting with base. The addition of water at this point in the purification may lessen the occurrence of heating when the eluting acid and base interact. In some instances, heating can cause air bubbles to form in the column, which can decrease the efficiency of the purification.

Following the elution with an acid, the column is eluted with base and the eluted material is collected. The eluting base can be any base that effectively elutes the desired astatine-211 in the purification mixture through the column. In some embodiments, the eluting base is an ammonium salt (i.e., has an ammonium ion). The ammonium-based eluting base can be ammonium hydroxide or an alkyl ammonium salt. In some embodiments, the eluting base is ammonium hydroxide having a concentration of about 1M to about 14.5M (concentrated). In other embodiments, the concentration of the ammonium hydroxide may be about 5M to about 10 M, about 8M to about 12M, about 10M to about 14M or about 12M to about 14.5M. In some embodiments, the ammonium hydroxide is concentrated.

Concentrating the eluted material can be performed by any applicable method known in the art. For example, in some embodiments, the eluted material is concentrated by distilling the eluting base from the eluted material. The distillation may be performed with or without the use of vacuum. In some embodiments, sodium hydroxide is added to the eluted material before concentration. For example, sodium hydroxide may be added to the eluted material prior to distillation.

Removal of the eluting base from the eluted material provides the purified astatine-211. In some embodiments, the purified astatine-211 is isolated as astatide-211, astatate-211, or a mixture thereof. In embodiments where sodium hydroxide is added to the eluted material before concentration, the purified astatine-211 is isolated as sodium astatide-211. In other examples, sodium hydroxide may be added to the receiving flask (as opposed to the distilling flask) when the eluted material is concentrated by distillation. In those examples volatile astatide is distilled into the receiving flask containing sodium hydroxide when the distilling solution becomes acid.

The isolated astatine may be substantially free of bismuth. For example, the isolated astatine-211 may contain less than 0.1% bismuth by weight. In other examples, the isolated astatine-211 may contain less than 10 ppm bismuth. In some embodiments, the isolated astatine-211 may contain less than 0.01% bismuth by weight. In other examples, the isolated astatine-211 may contain less than 1 ppm bismuth.

In addition to providing astatine-211 that is substantially free of bismuth, the described method also allows one of skill in the art to purify larger quantities of astatine and achieve great yields than other methods known in the art. For example, the purified astatine-211 may be isolated in greater than about 60% yield (non-decay corrected). Also, the method is capable of purifying greater than about 10 milliCuries of unpurified astatine-211.

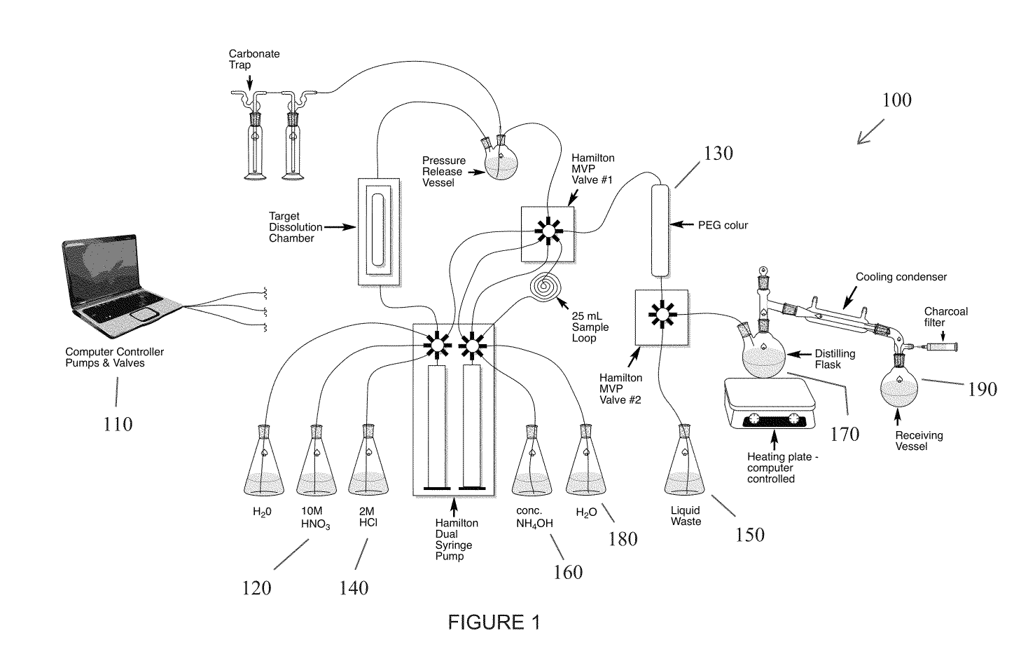

In an embodiment according to the second aspect of the invention, the method for purifying astatine-211 from bismuth metal may be automated. For example, a non-transitory physical computer readable medium comprising a set of instructions to cause one or more devices to carry out any of the steps described above. For example, FIG. 1 depicts an automated method for the purification of astatine-211 from bismuth metal.

The methods of all aspects of the invention as described herein can be carried out manually or may be used in conjunction with an automated system or computer. For instance, the methods can be performed using a computer of an automated system, such as computer 110 of system 100, in which purifying astatine-211 from bismuth metal is carried out automatically by software appropriate for that purpose. Computer software, or computer-readable media for use in the methods of this invention include: a computer readable medium comprising code executable by the computer to direct the automated system to perform functions, including: dissolving an amount of bismuth metal containing unpurified astatine-211 in nitric acid to provide a purification mixture; adding the purification mixture onto a polyethylene glycol (PEG)-coated resin column; eluting the column with an eluting acid; eluting the column with an eluting base and collecting the eluted material; concentrating the eluted material; and (isolating the purified astatine-211.

In certain embodiments of the invention, one or more control levels may be stored in a memory associated with a digital computer. After data corresponding to a determination of the amount of bismuth metal containing unpurified astatine-211 is obtained (e.g., from an appropriate analytical instrument), the amount of nitric acid to be added can be preprogrammed or the digital computer can determine an appropriate amount of nitric acid to be added. After dissolution of the bismuth metal containing unpurified astatine-211 in nitric acid, the digital computer can automatically direct a system to add the purification mixture onto a polyethylene glycol (PEG)-coated resin column. The computer can then calculate the amount of eluting acid and direct the system to elute the column with the calculated amount of eluting acid. The computer can then calculate the amount of eluting base and direct the system to elute the column with the calculated amount of eluting base, collect the eluted material, and concentrate the eluted material to provide purified astatine-211.

Accordingly, some embodiments of the invention may be embodied by computer code that is executed by a digital computer. The digital computer may be a mobile computing device, micro, mini, and/or large frame computer using any standard or specialized operating system such as a Windows based operating system. The code may be stored on any suitable computer readable media. Examples of computer readable media include magnetic, electronic, or optical disks, tapes, sticks, chips, etc. The code may also be written by those of ordinary skill in the art and in any suitable computer programming language including, C, C++, etc. The code may be executable by one or more processors of the digital computer, such as microprocessors, processor chips, central processing units (CPUs), graphics processing units (GPUs), digital signal processors (DSPs) and/or customized processing hardware; e.g,. Application Specific Integrated Circuits (ASICs), field-programmable gate arrays (FGPAs), etc.

Thus, some embodiments further comprises one or more non-transitory computer readable storage media comprising a set of instructions for causing one or more devices to carry out the method of any aspect or embodiment of the invention. In a further aspect, the present invention provides one or more non-transitory computer readable storage media, for automatically carrying out the methods of the invention on a computer linked to a device for purifying astatine-211 from bismuth metal. As used herein the term “computer readable medium” includes magnetic disks, optical disks, organic memory, and any other volatile (e.g., Random Access Memory (“RAM”)) or non-volatile (e.g., Read-Only Memory (“ROM”)) mass storage system readable by the CPU. The computer readable medium includes cooperating or interconnected computer readable medium, which exist exclusively on the processing system or be distributed among multiple interconnected processing systems that may be local or remote to the processing system. Any suitable devices for purifying astatine-211 from bismuth metal can be used, including but not limited to syringe pumps, dissolution chambers, resin columns, modular valve positioners and distillation apparatus.

FIG. 1 shows an automated method for purifying astatine-211 from bismuth metal according to an example system 100. A computer or controller 110 can control one or more of the pumps and valves used in the method. The amount of amount of bismuth metal containing unpurified astatine-211 can be preprogrammed or can be calculated by the computer 110 (optionally via an analytical instrument) or may be manually entered by a user. Using the amount of bismuth metal, a desired amount of nitric acid 120 can be calculated and added to the bismuth metal for dissolution to provide a purification mixture. The computer 110 may then cause the purification mixture to be added onto the purification column 130. The computer 110 may calculate the desired amount of eluting acid 140 and cause the eluting acid 140 to be added to the purification column 130, collecting the eluted acid as waste 150. The computer 110 may calculate the desired amount of eluting base 160 and cause the eluting base 160 to be added to the purification column 130, collecting the eluted material containing purified astatine-211 into a distillation flask 170. In some embodiments, the column 130 is eluted with water 180 before the elution with an eluting base 160. The computer 110 may determine the desired parameters to concentrate the eluted material (e.g., temperature or pressure). In some embodiments, the computer 110 may cause sodium hydroxide to be added to the distillation 170 or receiving flask 190. Upon distillation, the computer may determine the amount and percent yield of the isolated purified astatine-211.

### Experimental Methods:

### General Method for Preparing PEG-Resins for Columns

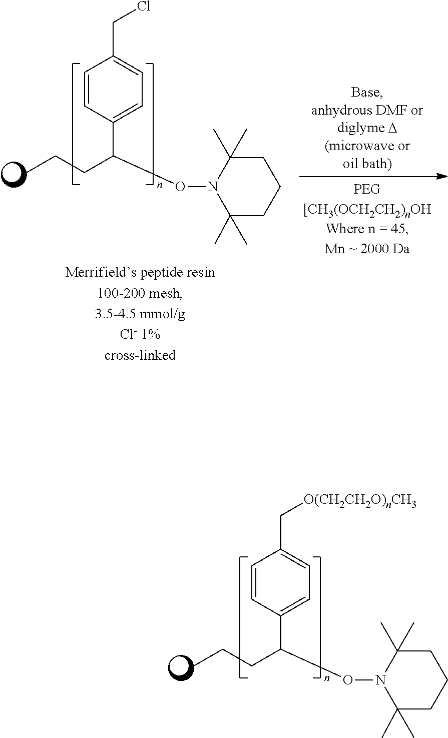

Merrifield resin (10 g, 3.5-4.5 mmol/g Cl—, 100-200 mesh, 1% cross-linked) and anhydrous diglyme (125 mL) were mixed in a 300-mL round-bottom flask and allowed to swell for 30 min at rt. Methoxy poly(ethylene glycol) (mPEG2000, 13 g or mPEG750, 4.84 g or mPEG5000, 32 g) and t-BuOK (13 mL, 1 M in THF) were added respectively, then the reaction solution was stirred and heated at 80° C. for 3 days under argon. After the temperature was cooled to rt, the solution was poured slowly to a 500-mL beaker containing 300 mL of H₂O with stirring. The yellowish solid product was then filtered by vacuum, washed with H₂O (3×200 mL), dried under vacuum to give the pale-yellow, hygroscopic solid product. Yield 18.18 g (mPEG2000), 15.08 g (mPEG750), 12.18 g (mPEG5000).

### Method for Preparing PEG Column

Weighed dry PEG-resin (2000) sample, 300 to 400 mg, was placed in a Mini Spe-ed cartridge. A cap was placed on the bottom of the cartridge and DI water was added in 100 μL aliquots until the resin appeared hydrated (approximately 500 μL to 600 μL, respectively). Bubbles, which slowly made their way to the top, were clearly seen. Eventually (about 20 min) a layer of water could be seen at the bottom of the resin. The column was sealed upright in scintillation vials and left over the weekend.

Method for Separation of At-211 from Bismuth on PEG Column (Manual Approach)

An irradiated bismuth target containing astatine-211 was dissolved in conc. HNO₃ to give a solution. The distillation flask was rinsed by addition of another 2 mL conc. HNO₃, then that solution was transferred to a distilling flask. The 10 mL ²¹¹At solution was used in the experiment. This solution was heated to remove the HNO₃ by distillation, then the residue was dissolved in 8 mL of 8M HCl, transferred to a scintillation vial. The entire 10 mL of solution was loaded at 2 mL/min onto a 800 mg PEG column that had been pre-equilibrated with 10 mL of 2M HCl , followed by 10 mL of 8M HCl. The column was washed with 4×10 mL solutions of 2M HCl. After elution 98% of the activity (23.9 mCi) remained on the column with only ˜2% being present collectively in the original flow-through and 4 washes. The column was eluted with 4 mL of conc. NH₄OH in approximately 0.5 mL fractions taken at 1 drop per 15 seconds. ²¹¹At activity was found in all 8 fractions, but post the 2^{nd} collected fraction, all later fractions contained smaller amounts than the previous fraction and the last fraction contained only 0.28 mCi. The total collected from the 8NH₄OH fractions was 17.33 mCi, or about 73% of the activity originally on the column (will be larger fraction if accounting for decay).

Method for Isolation of At-211 from Ammonium Hydroxide Solution

The ammonium hydroxide is separated from the At-211 by distillation. Prior to distillation, a 300 μL quantity of 4N NaOH was added to the round bottom distilling flask. Following that the NH₄OH solution containing At-211 was added to the flask. For the At-211 solution eluted on column A, 7.52 mCi At-211 was added. The distillation flask was connected to the distilling head. The distillation setup was then put on a hot plate pre-heated to 160° C., which was increased in temperature to 220° C. over ˜15 min. Distillation of the NH₄OH took about 30 min (not completely dry). A small amount of At-211 (20 μCi, 0.3%) distilled with the NH₄OH, but the bulk of At-211 (6.70 mCi) remained in the distilling flask. It was noted that there was very little solid in the distilling round bottom containing the At-211. A 300 μL quantity of H₂O was added to the round bottom, then 6.03 mCi (90%) was removed by pipet.

1. A method for purifying astatine-211 from bismuth metal, the method comprising:
dissolving an amount of bismuth metal containing unpurified astatine-211 in nitric acid to provide a purification mixture;
adding the purification mixture onto a polyethylene glycol (PEG)-coated resin column;
eluting the column with an eluting acid;
eluting the column with an eluting base and collecting the eluted material;
concentrating the eluted material; and
isolating the purified astatine-211

2. The method of claim 1, further comprising:
removing the nitric acid to provide an unpurified bismuth/astatine-211 residue; and
dissolving the residue in hydrochloric acid to provide the purification mixture.

3. The method of claim 1, wherein the unpurified astatine-211 is obtained from the activation of bismuth-209 in a cyclotron using an alpha beam at about 28 to about 29 MeV.

4. The method of claim 1, wherein the nitric acid has a concentration of about 8M to about 12M.

5. The method of claim 2, wherein the nitric acid has a concentration of about 8M to about 15M.

6. The method of claim 2, wherein the removing the nitric acid comprises distillation.

7. The method of claim 2, wherein the residue-dissolving hydrochloric acid has a concentration of about 8M to 12M.

8. The method of claim 1, wherein the PEG-coated resin column is a Merrifield resin column coated with mPEG-OH.

9. The method of claim 8, wherein the mPEG-OH is about 350 Dalton to about 5000 Dalton mPEG-OH.

10. The method of claim 1, wherein the eluting acid is HCl and has a concentration of about 1M to about 3M.

11. The method of claim 1, wherein the eluting base comprises ammonium ion.

12. The method of claim 11, wherein the eluting base is ammonium hydroxide.

13. The method of claim 11, wherein the eluting base comprises an alkyl ammonium salt.

14. The method of claim 1, further comprising eluting the column with water after the eluting with acid and before the eluting with base.

15. The method of claim 1, wherein the concentrating the eluted material comprises distillation.

16. The method of claim 15, wherein the distillation comprises a distillation flask containing sodium hydroxide for retention of purified astatine-211.

17. The method of claim 15, wherein the distillation comprises a receiving flask containing sodium hydroxide for retention of purified astatine-211.

18. The method of claim 1, wherein the purified astatine-211 is substantially free of bismuth.

19. The method of claim 1, wherein the purified astatine-211 comprises sodium astatide-211.

20. The method of claim 1, wherein one or more steps is automated.
